(19) United States
(12) Patent Application Publication
(10) Pub. No.: US 2014/0278902 A1
(43) Pub. Date: Sep. 18, 2014

(54) Return Processing Systems And Methods For A Price Comparison System

(71) Applicant: Wal-Mart Stores, Inc., Bentonville, AR (US)

(72) Inventors: Paul Kay Hatch, Bentonville, AZ (US); Ronaldo G. Benson, San Francisco, CA (US); Vivek Parekh, Fremont, CA (US); Joseph Y. Wang, San Bruno, CA (US); Venkata Syam Prakash Rapaka, Mountain View, CA (US)

(73) Assignee: Wal-Mart Stores, Inc., Bentonville, AZ (US)

(21) Appl. No.: 14/292,629

(22) Filed: May 30, 2014

Related U.S. Application Data
(63) Continuation-in-part of application No. 13/754,620, filed on Jan. 30, 2013.

(51) Int. Cl. G06Q 30/02

(52) U.S. Cl. CPC G06Q 30/0234
USPC 705/14.34

(57) ABSTRACT

Systems and methods are disclosed for evaluating a transaction concluded at a POS (point of sale) device. Prices for competitive retail stores within a geographic region of the POS may be evaluated after concluding a transaction. Price differences between items and corresponding prices in the third party data are identified. Where the purchase price exceeds the corresponding third-party price, a credit is assigned to the customer, such as in the form of a gift card or code that may be redeemed in a subsequent transaction. Credits may also be assigned to a debit card associated with a user, either with or without applying some multiplier. A return transaction record and updated record may be generated in response to the assigning of credits, the updated record listing as a purchase price the original price for each item less a credit assigned for that item.

### RELATED APPLICATIONS

This application is a continuation-in-part of U.S. application Ser. No. 13/754,620, filed Jan. 30, 2013. That application is incorporated herein by reference for all purposes.

### BACKGROUND

1. Field of the Invention

This invention relates to systems and methods for providing competitive pricing to consumers.

2. Background of the Invention

For a retailer such as Wal-Mart it is very important that customers receive the lowest possible price on items for sale and that customers are aware that the prices at Wal-Mart provide the best deal. For customers, it is likewise important to find the best possible deal on purchases. For both the retailer and the customer it can be difficult to evaluate pricing. Competitors may transmit advertisements on various media and publish advertisements and coupons in various publications. A customer must therefore wade through all of these for all items in order to find the best deal. Once found, price matching may enable a customer to buy all items at the same store rather than visit various retail stores. However, the time spent in reviewing advertisements each week is nonetheless inconvenient.

The systems and methods disclosed herein provide an improved approach for a retailer to ensure that prices paid by a customer are competitive and to ensure that the customer is aware of savings obtained by shopping at a retailer.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment suitable for implementing methods in accordance with embodiments of the invention;

FIG. 2 is schematic block diagram of a computer system suitable for implementing methods in accordance with embodiments of the invention;

FIG. 3 is a schematic block diagram of components implementing methods in accordance with an embodiment of the present invention; and

FIG. 4 is a process flow diagram of a method for providing a credit based on price differences with fraud estimation in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. In some embodiments, a customer may conduct a transaction at a POS (point of sale) device. The transaction may include the purchase of one or more items each having a purchase price paid by the customer. The transaction may be recorded in a transaction record, e.g. receipt, wherein each purchased item is represented by an item identifier. In some instances, the item identifier may be sufficient to also determine the price paid such that the transaction record need not be included in the transaction record. For example, a product database may record the price for a given item identifier at a given date and/or time. In other embodiments, the transaction record may also include the price. The transaction record may be a paper receipt printed for the customer and may also be an electronic record generated for a transaction by the POS and transmitted to a server.

A method may be executed with respect to the transaction. For example, subsequent to the first transaction, a server system may identify for each item identifier of at least a portion of the one or more item identifiers of a transaction, a third party record, the third party record corresponding to the each item identifier and having a third party price. For example, the third party record may include a competitor's advertisement or a transcription of pricing information from an advertisement by an entity that gathers pricing data.

The server system may identify one or more discounted identifiers of the one or more item identifiers, the third party price of the third party record corresponding to the discounted identifiers being less than the price paid for the one or more discounted identifiers by one or more price differences. The server system may then credit an account associated with the user identifier with an amount corresponding to the one or more price difference. The server system may then subsequently apply the amount toward a purchase price of a second transact subsequent to the first transaction.

In some embodiments, for a transaction record for which credits have been assigned, a return record may be associated therewith indicating that the items of the transaction were returned and a refund issued for the original purchase prices of the items. An updated transaction record indicating that the items were purchased at a reduced price, i.e. the updated price of an item may be the purchase price of each item less a credit assigned for each item. When issuing returns, the updated transaction record may then be used to determine an amount of a refund due.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Referring to FIG. 1, a network environment 100 may be used to implement methods as described herein. The environment 100 may include a server system 102a associated with a corporate parent or controlling entity having one or more retail establishments associated therewith. The retail establishments may house point of sale devices (POS) 106 on which transactions may be concluded. Records of transactions may be transmitted to the server system 102a by the POS 106a at the various retail establishments.

In some embodiments, data regarding third parties and used according to the methods disclosed herein may be gathered from various sources. For example, a server 102b of one entity may provide a website providing access to an online product database 104b, which may include access to product records including product prices and corresponding product identifiers and other descriptive information. A database 104b may also include a publicly accessible website or the like listing advertisements for products offered for sale in a retail establishment.

In some embodiments, data regarding third parties may be obtained from a server system 102c operated by a data gathering entity. For example, the server system 102c may store third party pricing data 104c. The pricing data may include data gathered from advertisements published by retail entities. Pricing data could include entries including fields such as an entity identifier, location, price, product identifier (e.g. UPC), a date the product was offered at the price, or the like. The pricing data may be gathered and be provided within N day of Hours from when it was published. For example, pricing data may be provided the next day, 48 hours, or 72 hours, after initially publicized.

The server system 102a may access and use user data 104a, which may include a plurality of user records 110. A user record 110 may be associated with a particular user who may be identified by a unique customer identifier. The user may have access to some or all of the data in the user record and a user name and password may be associated with the user record and with which a user may log in the server system 102a in order to obtain access to the user record 110.

The user record 110 may include such data as a purchase history 112a including a record of previous transactions conducted by the user associated with the user record 110 at the various POSs 106 associated with the server system 102a. The user record may further include a record of credits 112b assigned to the user associated with the user record as well as a redemption or usage of such credits. The methods by which the credits 112b are assigned and used are described in greater detail below.

In some embodiments, methods as described herein may evaluate or modify the purchase history 112a, credits 112b, and one or more other type of information about a user associated with the user record 110. In particular, the purchase history 112a may include, or be embodied as, transactions records 112c each recording specific aspects of a transaction, as discussed hereinbelow.

Customers may access the server system 102a in order to participate in the methods described herein by means of user computing devices 108 that may be embodied as desktop or laptop computers, tablet computers, smart phones, or the like. Communication among servers 102a-102c, POS 106, and workstations 108 may occur over a network 114 such as the Internet, local area network (LAN), wide area network (WAN) or any other network topology. Communication may be over any wired or wireless connection.

FIG. 2 is a block diagram illustrating an example computing device 200. Computing device 200 may be used to perform various procedures, such as those discussed herein. A server system 102a-102c, POS 106, and user computing device 108 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like. A server system 102a-102c may include one or more computing devices 200 each including one or more processors.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Referring to FIG. 3, a savings module 300 may ingest data such as a transaction record (e.g. receipt) from among user transaction records 112c. The savings module 300 may further take as input third party pricing data 104c. The third party pricing data 104c may be pricing data from different entities than the entity that conducted the transaction represented by the transaction record. The third party pricing data 104c may be data that reflecting prices offered on a same day as a date on which the transaction represented by the transaction record took place. The savings module 300 compares the prices of items in the transaction record to prices for corresponding items in the third party pricing data 104c. The savings module then assigns user credits 112b to an account of the user associated with the transaction or otherwise attributes credits 112b to the user.

A receipt management module 302 may adjust the transaction records 112c in response to the assigning of user credits 112b, as described in greater detail with respect to the method 400 of FIG. 4 described below. A return management module 304 may receive requests for refunds from a POS 106 and process them. A return management module 304 may process requests for refunds upon returning of an item. The return management module 304 may access and modify the transaction records 112c based on returns authorized and processed as described below with respect to the method 400 of FIG. 4, below.

A redemption module 306 may interact with one or more POSs 106 to apply the credits to subsequent transactions. For example, the redemption module 306 may issue a gift card, code for a gift card, assign credits to a gift card, or otherwise provide a message containing information that a user may use at a POS 106 in order to apply the credits to a transaction. The redemption module 306 may interact with the POS 102 in order to validate a gift card, code, or other representation of credits presented at the POS 106 when processing payment for a transaction. For example, a cashier or device may receive the code, scan the gift card, swipe the gift card through a magnetic reader, or otherwise input a representation of the gift card into the POS 106. The POS 106 may then transmit this information, or a representation thereof, to the redemption module 306. If the transmitted information is valid, the redemption module 302 may transmit authorization to the POS 106 to apply corresponding credits to the transaction. Otherwise, the redemption module 306 may transmit a rejection of the transmitted information and the POS 106 will not apply any corresponding credits to the transaction.

FIG. 4 illustrates an example of a method 400 that may be used to provide credits to users based on price difference between a price paid and third party prices. The method 400 may include receiving 402 a record of a transaction. A record of a transaction may include such data as a date of the transaction, a location where the transaction occurred, an identifier of the POS at which the transaction occurred, an identifier of the customer that was a party to the transaction, and other information. The transaction record may further include various <product,price> entries that list a product identifier and a price paid for the product corresponding to that product identifier. Other data may include taxes paid for the entire transaction and/or for specific item identifiers. Any discounts due to coupons or price matching may also be noted for each item identifier for which such price adjustments were applied. The transaction record may be transmitted from a POS 106 to a server system 102a. The transaction record may additionally or alternatively transmitted to a customer in electronic form and/or by means of a printed copy. The transaction record may be associated by the server system with the user data 110 of a user with whom the transaction was conducted, such as using a credit card number or identifier supplied to the POS at the time of concluding the transaction and included in, or associated with, the transaction record. For example, the transaction record may be in the form of an electronic receipt provided to the customer.

The step of receiving 402 the receipt may include receiving a transaction identifier from a user computing device 108 through a portal such as a website hosted by the server system 102. The transaction identifier may uniquely identify the transaction record and may be printed on a paper receipt to enable the customer to take advantage of the methods disclosed herein and/or for other purposes. Receiving 402 the receipt may include receiving, by the server system 102a, a selection of the transaction in a listing of transactions presented in a portal provided by the server system 102a or by an application for viewing receipts stored locally on a user computing device 108. For example, transactions may be made available to a user in the form of electronic receipts stored in an account of a user and recording transactions conducted by the user. In some embodiments, all transactions of a user may be submitted for review according to the method 400. For example, where a user has installed a mobile application for interfacing with the server system 102a, all transactions of a user may be automatically submitted for review according to the method 400. In some embodiments, transactions may be transmitted to the server system by 1) the user scanning a bar code or other optical code printed on a receipt with a user device 108, 2) the user device 108 transmitting some representation of the optical code to the server system 102a and 3) the server system 102a identifying a transaction record corresponding to the transmitted representation of the optical code.

In some embodiments, the server system 102a may limit a number of receipts that may be submitted by a customer, e.g. for a specific user account. For example, N transactions may be process per week for the customer. In some embodiments, multiple limits on receipts for multiple corresponding time period may be imposed. For example, only N transactions per week or M transactions per month may be allowed by the server system 102a to be processed according to the methods described herein for purposes of determining a credit based on price differences.

The method 400 may further include identifying 404 from the received transaction record the item identifiers of items purchased as part of the transaction and the price for each item. For example, fields of the form <item identifier, price paid> may be filled with the item identifier and purchase price for some or all items listed as having been purchased in a transaction record. The item identifier may be a proprietary product identifier for a product catalog of a merchant or a universal identifier (e.g. a universal product code (UPC)).

For some or all of the identified 404 items, corresponding items may be identified in third party pricing data. In particular, a lowest price for each item identifier may be identified among the third party pricing data. As noted above, pricing data may include advertised prices exclusively. Pricing data may also include the sale price for some items regardless of whether that price is advertised. Pricing data searched to identify corresponding third party prices may be limited to pricing data for retail stores within a threshold proximity of the POS or retail location identified by the transaction record that is the subject of the method 400. For example, the threshold may reference a geographical or political region (neighborhood, city, county, state, etc.) or may specify a circular area having a radius R with respect to the POS or store location indicated in the transaction record.

Identifying the lowest price among the third party pricing data for each item identifier of at least a portion of the item identifiers in a transaction may include determining a per-unit cost for corresponding items in the third party pricing data. For example, if a product corresponding to an item identifier is offered for sale as a buy N at price P per unit and get M free, then the price of an individual instance of that product may be prorated to be (N/(N+M))*P. This prorated price may then be used for purposes of determining whether a price is the lowest as compared to prices offered for that product by other entities and for comparison with the purchase price for the corresponding item identifier in the transaction record. In some instances, where items are sold by a unit of measure, such as weight, the cost per unit weight for an item may also be determined form the third party pricing data. For example, this approach may be applied to produce, meat, or the products sold by weight, volume, or some other unit of measurement. In some instances, products may be offered for sale at a certain price at limit of N per customer. Accordingly, where a third party promotion imposes such a limit, this limit may likewise be imposed when assigning credits. For example, where a third party price is offered only for N items and a customer buys M items, M being greater than N, the customer may be assigned a credit based on the difference between the purchase price paid for N of the M items and the third party price. For the remaining M−N items a credit may still be assigned if some other promotion or third party price is found to be lower than the purchase price paid.

The method 400 may further include, for each item identifier of some or all of the item identifiers of the transaction record determining 408 a price difference between the lowest price found for the each item identifier in the third party pricing data. A credit for the transaction record according to the price differences determined at step 408 may then be determined 410. For example, a credit equal to Pₜ−P₃ may be assigned for each item identifier for which Pₜ−P₃ is a positive number, where to Pₜ is the price paid as indicated by the transaction record and P₃ is the lowest corresponding third party price identified at step 406 for the item identifier.

The sum of the credits for each item identifier as determined 410 may then be assigned to the user associated with the transaction record, such as by assigning a credit equal to the sum of the credits to an account associated with a same user identifier as included in the transaction record.

The method 400 may further include evaluating 412 a customer history with respect to the received 402 transaction or recent transactions of a user in order to determine if the received 402 transaction or recent transactions of a user indicate fraudulent activity. If flags are found 414 to have been generated based on the evaluation 412, then the transaction and/or other data determined by the evaluation 412 to indicate fraudulent activity may be transmitted for display to a representative of a retailer. An evaluation of this information may then be received 416. If the evaluation validates 418 the transaction (indicates it is not likely fraudulent), then steps 420 and 422 may be performed as described below. If not, then the method 400 may end, i.e. no credits are assigned 420 based on the transaction.

In some embodiment, the method 400 may include assigning 420 a credit, such as by generating a gift card, gift code, coupon, or some other data used to uniquely identify an account to which the credit was assigned or to represent the value of the credit. In some embodiments, the credit may be assigned to a debit card account. For example, a debit card having a checking account associated therewith or used exclusively by means of a debit card. For example, an AM-EX BLUEBIRD account provided by cooperation between WAL-MART and AMERICAN EXPRESS. The credit may also be multiplied by some multiplier greater than one, such as two, and the result of the multiplication assigned to the account of a user. In some embodiments, a user may be presented a choice between 1) a gift card or code or other assignment of credit to the user and 2) assignment of a credit to a debit card after applying some multiple. In some embodiments, a credit may be assigned in the form of a simple credit, gift card, or gift code by default.

In some embodiments, credits assigned according to the methods described herein may be transmitted for display in a portal with listing credits for various transactions. Upon selecting of a transaction a portal may display information about a specific transaction and the credits assigned based thereon according to the methods described herein. In some embodiments, a portal may be displayed summarizing information for a specific transaction, the portal including a map displaying the location of third party stores at which a lower price was found and for which a credit was assigned according to the methods disclosed herein.

In some embodiments, the method 400 may include generating 422 a return record for the purchase price for all items for which a lower price was found among third party pricing data and for which a credit was assigned 420. The method 400 may further include generating 424 an updated transaction recording the items for which a lower price was found and credits assigned as having been purchased for an updated purchase price. The updated purchase price may be the original purchase price reduced by the amount of credit assigned based on a difference between the original purchase price and a lower third part price for that item. In some embodiments, steps 422 and 424 may be performed by the receipt management module 302 in response to detecting assignment of credit by the savings module 300.

For example, for a given transaction record, a total credit including a sum of credits CA, CB, and CC may be assigned for one or more item identifiers A, B, and C of the transaction record having prices paid PA, PB, and PC, respectively. CA, CB, and CC may be equal to, or determined based on, a difference between PA, PB, and PC and corresponding third party prices TA, TB, TC, respectively. The transaction records 112c may be modified by generating 422 a return record indicating that products A, B, and C were returned and a refund of the purchase prices PA, PB, and PC generated. Another transaction record may then be generated indicating that products A, B, and C were purchased and the purchase price for each was PA−CA, PB−CB, and PC−CC, respectively.

The method 400 may further include redeeming 426 the credit. The credit may be redeemed in any manner known in the art. For example, a code may be transmitted to the user. The code may then be presented at the POS 106. The code may be input to the POS that either independently validates the code or transmits it to the server system 102a, such as to the redemption module 306. Upon determining that the code is valid, such as by receiving a response from the server system 102a (e.g. redemption module 306) indicating that it is valid, the POS 106 may apply the corresponding credit to a transaction. The code may include text (letters, numbers, other typographic symbols), an optical code (bar code, quick response (QR) code, or the like). In some embodiments, the server system 102a may invoke mailing of a gift card to the customer or crediting of an account of the customer that has a card with a magnetic strip encoding an account identifier (e.g. debit card).

The method 400 may include receiving 428 a return request, such as by a return management module 304. The return request may be received by the server system 102a from a POS 106 at which a customer has attempted to return an item. The return request may include a transaction identifier and identify one or more items from a transaction that customer is returning. The return request may further include one or both of an identifier of a store at which the transaction occurred; a date and time when the transaction occurred; universal product code (UPC) or other identifier for returned items; a quantity of items to be returned; a weight of items to be returned; pricing information for the items to be returned; and a store authorization code. The transaction identifier may correspond to a specific transaction record 112c. The method 400 may further include evaluating the request and if the evaluation indicates that a refund is appropriate, authorizing 430 a refund. Authorizing 430 the refund may include transmitting an indicator that the refund as well as an amount that is authorized to be refunded, which may be different than the price on a customer's receipt presented at the POS 106 due to credits previously assigned.

For example, if a credit has been assigned and a return record and updated transaction record have been generated 422, 424, then the method 400 may include authorizing 430, such as by refund management module 304, a refund for the purchase price in the updated transaction record generated at step 424, i.e. the original price for an item for which a refund is requested less any credit assigned for that item. The server system 102a may also include in generating 432 a return record indicating that refunds have been issued for the items referenced in the return request. The return record may be linked to or included in the transaction record for the original transaction evaluated at step 402. In this manner the server system 102a may determine that a refund has already been issued for an item referenced in a request, in which case the server system may deny a request for a refund. In some embodiments, a return request may be denied if any of the information in the return request does not match corresponding information in a transaction record 112c for which the return request is requesting a refund one or more items. In some embodiments, a store manager may have discretion to override a rejection of a return request that has been denied for any of the foregoing reasons, such as by inputting an authorization code that may be transmitted with a return request to the server system 102a.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A system comprising one or more processors and one or more memory devices operably coupled to the one or more processors, the one or more memory devices storing executable and operational code effective to cause the one or more memory devices to:
for a first transaction record of a user, determine one or more price differences between prices paid for items of the first transaction and third party prices for the items;
credit an account associated with the user with an amount corresponding to the one or more price differences;
generate a return record for at least a portion of the items of the first transaction for which the one or more price differences were determined; and
generate a second transaction record listing one or more updated prices for the at least the portion of the items, the updated prices being the prices paid for the at least the portion of the items reduced by the one or more price differences.

2. The system of claim 1, wherein the executable and operational data are further effective to credit the account associated with the user with the amount corresponding to the one or more price differences by:
generating a redemption code having the amount corresponding to the one or more price differences associated therewith.

3. The system of claim 2, wherein the operational and executable data are further effective to cause the one or more processors to:
receive a request to redeem the redemption code from the user; and
issue a gift card to the user.

4. The system of claim 1, wherein the executable and operational data are further effective to identify for each item of the first transaction, a third party price corresponding to the each item by:
identifying a geographic location of a point of sale (POS) at which the first transaction was concluded; and
identifying as the third party price for the each item a price offered for the each item at a retail location within a threshold distance from the geographic location of the POS.

5. The system of claim 1, wherein the executable and operational data are further effective to receive a record of the first transaction concluded on a point of sale (POS) by:
receiving, from a user computer, a transaction identifier; and
retrieving the record of the first transaction using the transaction identifier.

6. The system of claim 1, wherein the executable and operational data are further effective to:
receive from a point of sale (POS) a request for refund for one or more return items of the items of the first transaction; and
in response to receiving the request for refund, transmit authorization to refund the updated prices for the one or more return items.

7. The system of claim 6, wherein the executable and operational data are further effective to:
determine that the account associated with the user has been credited with an amount corresponding to the one or more price differences with respect to the first transaction; and
in response to determining that that the account associated with the user has been credited with an amount corresponding to the one or more price differences with respect to the first transaction, instruct the POS to issue in-store credit for the refund.

8. A computer program product, the computer program product being embodied in a non-transitory computer readable storage medium and comprising computer instructions for:
receiving a record of a first transaction concluded on a point of sale (POS), the record including a user identifier, one or more item identifiers, and a price paid for each item identifier of the one or more item identifiers;
subsequent to the first transaction, identifying for each item identifier of at least a portion of the one or more item identifiers, a third party record, the third party record corresponding to the each item identifier and having a third party price;
subsequent to the first transaction, identifying one or more discounted identifiers of the one or more item identifiers, the third party price of the third party record corresponding to the discounted identifiers being less than the price paid for the one or more discounted identifiers by one or more price differences;
crediting the account associated with the user identifier with the amount corresponding to the one or more price differences;
generate a return record for the one or more item identifiers; and
generate a second transaction record listing one or more updated prices for the one or more item identifiers, the one or more updated prices being the prices paid for the one or more item identifiers reduced by the one or more price differences; and
applying an amount of credit in the account associated with the user identifier toward a purchase price of a second transaction subsequent to the first transaction.

9. The computer readable medium of claim 8, wherein crediting the account associated with the user identifier with the amount corresponding to the one or more price differences comprises:
generating a redemption code having the amount corresponding to the one or more price differences associated therewith.

10. The computer readable medium of claim 9, further comprising computer instructions for:
receiving a request to redeem the redemption code from a user associated with the first user identifier; and
issuing a gift card to the user associated with the first user identifier.

11. The computer readable medium of claim 8, wherein identifying for each item identifier of the at least the portion of the one or more item identifiers, the third party record, the third party record corresponding to the each item identifier and having the third party price further comprises:
identifying a geographic location of the POS; and
identifying as the third party record for the each item identifier of the at least the portion of the one or more identifiers a third party record corresponding to a retail location within a threshold distance from the geographic location of the POS and excluding third party records corresponding to retail locations outside of the threshold distance from the geographic location.

12. The computer readable medium of claim 8, wherein receiving the record of the first transaction concluded on the POS further comprises:
receiving, from a user computer, a transaction identifier; and
retrieving the record of the first transaction using the transaction identifier.

13. The computer readable medium of claim 8, further comprising computer instructions for:
receiving from a point of sale (POS) a request for refund for one or more return items of the items of the first transaction; and
in response to receiving the request for refund, transmitting authorization to refund the updated prices for the one or more return items.

14. The computer readable medium of claim 13, further comprising computer instructions for:
determining that the account associated with the user identifier has been credited with an amount corresponding to the one or more price differences with respect to the first transaction; and
in response to determining that that the account associated with the user identifier has been credited with an amount corresponding to the one or more price differences with respect to the first transaction, instructing the POS to issue in-store credit for the refund.

15. A method comprising performing, by a computer system, the steps of:
receiving a record of a first transaction concluded on a point of sale (POS), the record including a user identifier, one or more item identifiers, and a price paid for each item identifier of the one or more item identifiers;
subsequent to the first transaction, identifying for each item identifier of at least a portion of the one or more item identifiers, a third party record, the third party record corresponding to the each item identifier and having a third party price;
subsequent to the first transaction, identifying one or more discounted identifiers of the one or more item identifiers, the third party price of the third party record corresponding to the discounted identifiers being less than the price paid for the one or more discounted identifiers by one or more price differences;
crediting the account associated with the user identifier with the amount corresponding to the one or more price differences;
generate a return record for the one or more item identifiers; and
generate a second transaction record listing one or more updated prices for the one or more item identifiers, the one or more updated prices being the prices paid for the one or more item identifiers reduced by the one or more price differences; and
applying an amount of credit in the account associated with the user identifier toward a purchase price of a second transaction subsequent to the first transaction.

16. The method of claim 15, wherein crediting the account associated with the user identifier with the amount corresponding to the one or more price differences comprises:
generating a redemption code having the amount corresponding to the one or more price differences associated therewith.

17. The method of claim 16, further comprising:
receiving a request to redeem the redemption code from a user associated with the first user identifier; and
issuing a gift card to the user associated with the first user identifier.

18. The method of claim 15, wherein identifying for each item identifier of the at least the portion of the one or more item identifiers, the third party record, the third party record corresponding to the each item identifier and having the third party price further comprises:
identifying a geographic location of the POS; and
identifying as the third party record for the each item identifier of the at least the portion of the one or more identifiers a third party record corresponding to a retail location within a threshold distance from the geographic location of the POS and excluding third party records corresponding to retail locations outside of the threshold distance from the geographic location.

19. The method of claim 15, further comprising:
receiving from a point of sale (POS) a request for refund for one or more return items of the items of the first transaction; and
in response to receiving the request for refund, transmitting authorization to refund the updated prices for the one or more return items.

20. The method of claim 19, further comprising:
determining that the account associated with the user identifier has been credited with an amount corresponding to the one or more price differences with respect to the first transaction; and
in response to determining that that the account associated with the user identifier has been credited with an amount corresponding to the one or more price differences with respect to the first transaction, instructing the POS to issue in-store credit for the refund.
